(19) United States
(12) Patent Application Publication
(10) Pub. No.: US 2011/0310858 A1
(43) Pub. Date: Dec. 22, 2011

(54) BEACON SIGNALING METHOD AND APPARATUS

(75) Inventors: Yeliz Tokgoz, San Diego, CA (US); Peter John Black, San Diego, CA (US); Mehmet Yavuz, San Diego, CA (US); Joseph B. Soriaga, San Diego, CA (US); Vansh Pal Singh Makh, San Diego, CA (US)

(73) Assignee: QUALCOMM Incorporated, San Diego, CA (US)

(21) Appl. No.: 13/161,284

(22) Filed: Jun. 15, 2011

Related U.S. Application Data
(60) Provisional application No. 61/355,498, filed on Jun. 16, 2010.

(51) Int. Cl. H04W 72/04

(52) U.S. Cl. 370/336

(57) ABSTRACT

Systems and methods are described herein for managing beacon signaling in a wireless communication system. A method described herein includes identifying a neighboring macrocell and a time division multiplexing (TDM) channel offset of the neighboring macrocell, the channel offset corresponding to at least one of a signaling channel or an overhead channel; selecting a local channel offset that differs from the channel offset of the neighboring macrocell; and generating a transmission schedule such that first transmissions are omitted for at least a portion of transmission intervals of the neighboring macrocell; wherein the transmission intervals of the neighboring macrocell are identified according to the channel offset of the neighboring macrocell and wherein the first transmissions include at least one of pilot transmissions, medium access control (MAC) transmissions or traffic transmissions.

### CROSS-REFERENCES TO RELATED APPLICATIONS

This application claims the benefit of U.S. Provisional Application No. 61/355,498, filed Jun. 16, 2010, entitled “BEACON SIGNALING METHOD AND APPARATUS,” the entirety of which is herein incorporated by reference for all purposes.

### BACKGROUND

Wireless communication devices are incredibly widespread in today's society. For example, people use cellular phones, smart phones, personal digital assistants, laptop computers, pagers, tablet computers, etc. to send and receive data wirelessly from countless locations. Moreover, advancements in wireless communication technology have greatly increased the versatility of today's wireless communication devices, enabling users to perform a wide range of tasks from a single, portable device that conventionally required either multiple devices or larger, non-portable equipment.

A mobile device communicates within a cellular communications environment via a system of network cells that provide communication coverage for corresponding geographic areas. Such networks conventionally include macrocells, which provide communication coverage for a substantially large geographic area (e.g., covering a radius of over 2 km, etc.). To improve network coverage and capacity for a more limited area, such as that corresponding to a building or other indoor area, smaller scale cells, such as femtocells, may be employed. A femtocell connects to an associated communications network via a broadband connection (e.g., digital subscriber line (DSL), cable, fiber-optic, etc.) to extend coverage of the communications network to a limited number of devices within a coverage area of the femtocell.

Beacons are utilized in wireless communication networks with deployed femtocells in order to assist access terminals (AT) in finding femtocells, also referred to as femto base stations (BSs). When multiple carriers are available in the macro network, an AT can be in idle mode on one of these carriers. Once an AT comes within range of an associated femtocell, the AT utilizes various mechanisms to detect the femto BS and redirect to the frequency of the femtocell. To achieve this, a femto BS radiates a beacon on each macro frequency, which includes pilot information, medium access control (MAC) bursts and control channel (CC) information. The CC overhead messages of the beacon redirect the idle mode AT onto the femtocell frequency. However, these beacons have the potential to interfere with the downlink of the macro network.

### SUMMARY

A system for managing transmissions within a wireless communication system as described herein includes a neighbor cell analysis module configured to identify a neighboring macrocell and a time division multiplexing (TDM) channel offset of the neighboring macrocell, the channel offset corresponding to at least one of a signaling channel or an overhead channel; an offset selection module communicatively coupled to the neighbor cell analysis module and configured to select a local channel offset that differs from the channel offset of the neighboring macrocell; and a scheduler module communicatively coupled to the neighbor cell analysis module and the offset selection module and configured to generate a transmission schedule such that first transmissions are omitted for at least a portion of transmission intervals of the neighboring macrocell; where the transmission intervals of the neighboring macrocell are identified according to the channel offset of the neighboring macrocell and where the first transmissions include at least one of pilot transmissions, medium access control (MAC) transmissions or traffic transmissions.

Implementations of the system may include one or more of the following features. The offset selection module is further configured to select the local channel offset such that a distance in time between the local channel offset and the channel offset of the neighboring macrocell is maximized. The channel offset of the neighboring macrocell is an integer N between 0 and 3 and the local channel offset is selected according to (N+2) mod 4. The scheduler module is further configured to generate the transmission schedule such that the first transmissions are omitted for at least a portion of the transmission intervals of the neighboring macrocell that correspond to interlaces in which no data are locally transmitted. The scheduler module is further configured to schedule the first transmissions for a warmup period preceding a time interval corresponding to a synchronous control channel (SCC) boundary of the neighboring macrocell. The scheduler module is further configured to extend the warmup period beyond the time interval corresponding to the SCC boundary of the neighboring macrocell as a function of neighbor list size indicated by the neighboring macrocell. The scheduler module is further configured to schedule pilot and traffic burst transmissions at each local channel slot defined according to the local channel offset. The scheduler module is further configured to schedule pilot burst transmissions at one or more of a first half-slot immediately preceding each local channel slot or a second half-slot immediately following each local channel slot. The neighboring macrocell is a strongest neighboring macrocell. The neighbor cell analysis module is further configured to identify a plurality of neighboring macrocells and a plurality of TDM channel offsets of the neighboring macrocells and the scheduler module is further configured to generate the transmission schedule such that the first transmissions are omitted for at least a portion of the transmission intervals of the plurality of neighboring macrocells as determined according to channel offsets of the plurality of neighboring macrocells.

A method described herein includes identifying a neighboring macrocell and a TDM channel offset of the neighboring macrocell, the channel offset corresponding to at least one of a signaling channel or an overhead channel; selecting a local channel offset that differs from the channel offset of the neighboring macrocell; and generating a transmission schedule such that first transmissions are omitted for at least a portion of transmission intervals of the neighboring macrocell; where the transmission intervals of the neighboring macrocell are identified according to the channel offset of the neighboring macrocell and where the first transmissions include at least one of pilot transmissions, MAC transmissions or traffic transmissions.

Implementations of the method may include one or more of the following features. Selecting the local channel offset such that a distance in time between the local channel offset and the channel offset of the neighboring macrocell is maximized. The channel offset of the neighboring macrocell is an integer N between 0 and 3 and selecting the local channel offset includes selecting the local channel offset according to (N+2) mod 4. Generating the transmission schedule such that the first transmissions are omitted for at least a portion of the transmission intervals of the neighboring macrocell that correspond to interlaces in which no data are locally transmitted. Scheduling the first transmissions for a warmup period preceding a time interval corresponding to a SCC boundary of the neighboring macrocell. Extending the warmup period beyond the time interval corresponding to the SCC boundary of the neighboring macrocell as a function of neighbor list size indicated by the neighboring macrocell. Scheduling pilot and traffic burst transmissions at each local channel slot defined according to the local channel offset. Scheduling pilot burst transmissions at one or more of a first half-slot immediately preceding each local channel slot or a second half-slot immediately following each local channel slot. The neighboring macrocell is a strongest neighboring macrocell. Identifying a plurality of neighboring macrocells and a plurality of TDM channel offsets of the neighboring macrocells and generating the transmission schedule such that the first transmissions are omitted for at least a portion of the transmission intervals of the plurality of neighboring macrocells as determined according to channel offsets of the plurality of neighboring macrocells.

A system for controlling interference associated with transmissions within a wireless communication system as described herein includes means for identifying a neighboring macrocell, means for identifying a TDM channel offset of the neighboring macrocell, means for selecting a local channel offset that differs from the channel offset of the neighboring macrocell, and means for generating a transmission schedule such that first transmissions are omitted for at least a portion of transmission intervals of the neighboring macrocell, where the transmission intervals of the neighboring macrocell are identified according to the channel offset of the neighboring macrocell and where the first transmissions include at least one of pilot transmissions, MAC transmissions or traffic transmissions.

Implementations of the system may include one or more of the following features. The means for selecting the local channel offset is configured to select the local channel offset such that a distance in time between the local channel offset and the channel offset of the neighboring macrocell is maximized. The channel offset of the neighboring macrocell is an integer N between 0 and 3 and the local channel offset is selected according to (N+2) mod 4. The means for generating the transmission schedule is configured to generate the transmission schedule such that the first transmissions are omitted for at least a portion of the transmission intervals of the neighboring macrocell that correspond to interlaces in which no data are locally transmitted. The means for generating the transmission schedule is configured to schedule the first transmissions for a warmup period preceding a time interval corresponding to a SCC boundary of the neighboring macrocell. The means for generating the transmission schedule is further configured to extend the warmup period beyond the time interval corresponding to the SCC boundary of the neighboring macrocell according to a neighbor list size indicated by the neighboring macrocell. The means for generating the transmission schedule is configured to schedule pilot and traffic burst transmissions at each local channel slot defined according to the local channel offset. The means for generating the transmission schedule is further configured to schedule pilot burst transmissions at one or more of a first half-slot immediately preceding each local channel slot or a second half-slot immediately following each local channel slot. The neighboring macrocell is a strongest neighboring macrocell. The means for identifying the neighboring macrocell is configured to identify a plurality of neighboring macrocells, the means for identifying the TDM channel offset is configured to identify a plurality of TDM channel offsets of the neighboring macrocells, and the means for generating the transmission schedule is configured to generate the transmission schedule such that the first transmissions are omitted for at least a portion of the transmission intervals of the plurality of neighboring macrocells as determined according to channel offsets of the plurality of neighboring macrocells.

A computer program product described herein resides on a processor-readable medium and includes processor-readable instructions configured to cause a processor to identify a neighboring macrocell and a TDM channel offset of the neighboring macrocell, select a local channel offset that differs from the channel offset of the neighboring macrocell, and generate a transmission schedule such that first transmissions are omitted for at least a portion of transmission intervals of the neighboring macrocell, where the transmission intervals of the neighboring macrocell are identified according to the channel offset of the neighboring macrocell and where the first transmissions include at least one of pilot transmissions, MAC transmissions or traffic transmissions.

Implementations of the computer program product may include one or more of the following features. The instructions configured to cause the processor to select the local channel offset are further configured to cause the processor to select the local channel offset such that a distance in time between the local channel offset and the channel offset of the neighboring macrocell is maximized. The channel offset of the neighboring macrocell is an integer N between 0 and 3 and selecting the local channel offset comprises selecting the local channel offset according to (N+2) mod 4. The instructions configured to cause the processor to generate the transmission schedule comprises instructions configured to cause the processor to generate the transmission schedule such that the first transmissions are omitted for at least a portion of the transmission intervals of the neighboring macrocell that correspond to interlaces in which no data are locally transmitted. The instructions configured to cause the processor to generate the transmission schedule comprises instructions configured to cause the processor to schedule the first transmissions for a warmup period preceding a time interval corresponding to a SCC boundary of the neighboring macrocell. The instructions configured to cause the processor to generate the transmission schedule comprises instructions configured to cause the processor to extend the warmup period beyond the time interval corresponding to the SCC boundary of the neighboring macrocell as a function of neighbor list size indicated by the neighboring macrocell. The instructions configured to cause the processor to generate the transmission schedule comprises instructions configured to cause the processor to schedule pilot and traffic burst transmissions at each local channel slot defined according to the local channel offset. The instructions configured to cause the processor to generate the transmission schedule comprises instructions configured to cause the processor to schedule pilot burst transmissions at one or more of a first half-slot immediately preceding each local channel slot or a second half-slot immediately following each local channel slot. The neighboring macrocell is a strongest neighboring macrocell. The instructions configured to cause the processor to identify are further configured to cause the processor to identify a plurality of neighboring macrocells and a plurality of TDM channel offsets of the neighboring macrocells, and the instructions configured to cause the processor to generate the transmission schedule are further configured to cause the processor to generate the transmission schedule such that the first transmissions are omitted for at least a portion of the transmission intervals of the plurality of neighboring macrocells as determined according to channel offsets of the plurality of neighboring macrocells.

Items and/or techniques described herein may provide one or more of the following capabilities, as well as other capabilities not mentioned. Utilization of mobile device power in association with searching for new and/or obsolete femtocells can be reduced or eliminated. Mobile device efficiency associated with femtocell usage can be increased. Efficient femtocell proximity data updating can be flexibly applied to any wireless communication technology and can be implemented at a mobile device and/or a communication network according to device capability. Network capacity can be increased via reduction of superfluous proximity information reports. While at least one item/technique-effect pair has been described, it may be possible for a noted effect to be achieved by means other than that noted, and a noted item/technique may not necessarily yield the noted effect.

### BRIEF DESCRIPTION OF THE DRAWINGS

FIG. 1 is a schematic diagram of a wireless telecommunication system.

FIG. 2 is a block diagram of a wireless communication system employing femtocells.

FIG. 3 is a block diagram of components of a femtocell shown in FIG. 2.

FIG. 4 is a partial functional block diagram of a system for managing femtocell beacon signaling in a wireless communication system.

FIG. 5 is an illustrative view of an example packet format that can be utilized for communication within a wireless communication system.

FIGS. 6-7 illustrate an example technique for managing beacon transmissions of a femtocell in a wireless communication system.

FIG. 8 is a block flow diagram of a process of controlling transmission of beacons by a femtocell in a wireless communication system.

### DETAILED DESCRIPTION

The following description is provided with reference to the drawings, where like reference numerals are used to refer to like elements throughout. While various details of one or more techniques are described herein, other techniques are also possible. In some instances, well-known structures and devices are shown in block diagram form in order to facilitate describing various techniques.

Techniques are described herein for beacon signaling by a femtocell, or other smaller cell, in a wireless communication system that avoids interference to a macro control channel. As beacons transmitted by a femtocell have the potential to interfere with the downlink of a macro network that provides coverage for a geographical area that includes the femtocell, it is desirable to manage the transmit power of such beacons. Techniques herein provide for a beacon signaling method that avoids interfering with macro network overhead and/or signaling channels, e.g., a macro network CC or the like, without adjusting the overall beacon transmit power. This is achieved by, e.g., using a selected combination of a beacon CC offset selection with a gated beacon transmission scheme. This technique, as well as other techniques that can be applied to beacon transmission, are described in further detail below.

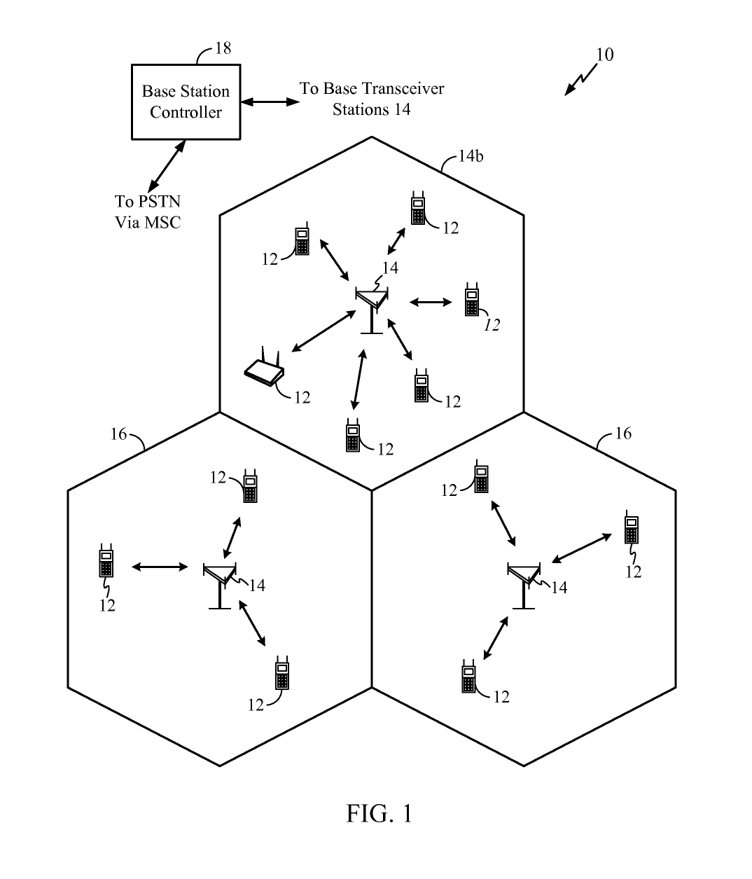

Referring to FIG. 1, a wireless communication system 10 includes mobile access terminals 12 (ATs), base transceiver stations (BTSs) or base stations 14 disposed in cells 16, and a base station controller (BSC) 18. The system 10 may support operation on multiple carriers (waveform signals of different frequencies). Multi-carrier transmitters can transmit modulated signals simultaneously on the multiple carriers. Each modulated signal may be a Code Division Multiple Access (CDMA) signal, a Time Division Multiple Access (TDMA) signal, an Orthogonal Frequency Division Multiple Access (OFDMA) signal, a Single-Carrier Frequency Division Multiple Access (SC-FDMA) signal, etc. Each modulated signal may be sent on a different carrier and may carry pilot, overhead information, data, etc.

The base stations 14 can wirelessly communicate with the mobile devices 12 via antennas. Each of the base stations 14 may also be referred to as a base station, an access point, an access node (AN), a Node B, an evolved Node B (eNB), etc. The base stations 14 are configured to communicate with the mobile devices 12 under the control of the BSC 18 via multiple carriers. Each of the base stations 14 can provide communication coverage for a respective geographic area, here the respective cells 16. Each of the cells 16 of the base stations 14 is partitioned into multiple sectors as a function of the base station antennas.

The system 10 may include only macro base stations 14 or it can have base stations 14 of different types, e.g., macro, pico, and/or femto base stations, etc. A macro base station may cover a relatively large geographic area (e.g., several kilometers in radius) and may allow unrestricted access by terminals with service subscription. A pico base station may cover a relatively small geographic area (e.g., a pico cell) and may allow unrestricted access by terminals with service subscription. A femto or home base station may cover a relatively small geographic area (e.g., a femtocell) and may allow restricted access by terminals having association with the femtocell (e.g., terminals for users in a home).

The mobile devices 12 can be dispersed throughout the cells 16. The mobile devices 12 may be referred to as terminals, mobile stations, mobile devices, user equipment (UE), subscriber units, etc. The mobile devices 12 shown in FIG. 1 include cellular phones and a wireless router, but can also include personal digital assistants (PDAs), other handheld devices, netbooks, notebook computers, etc.

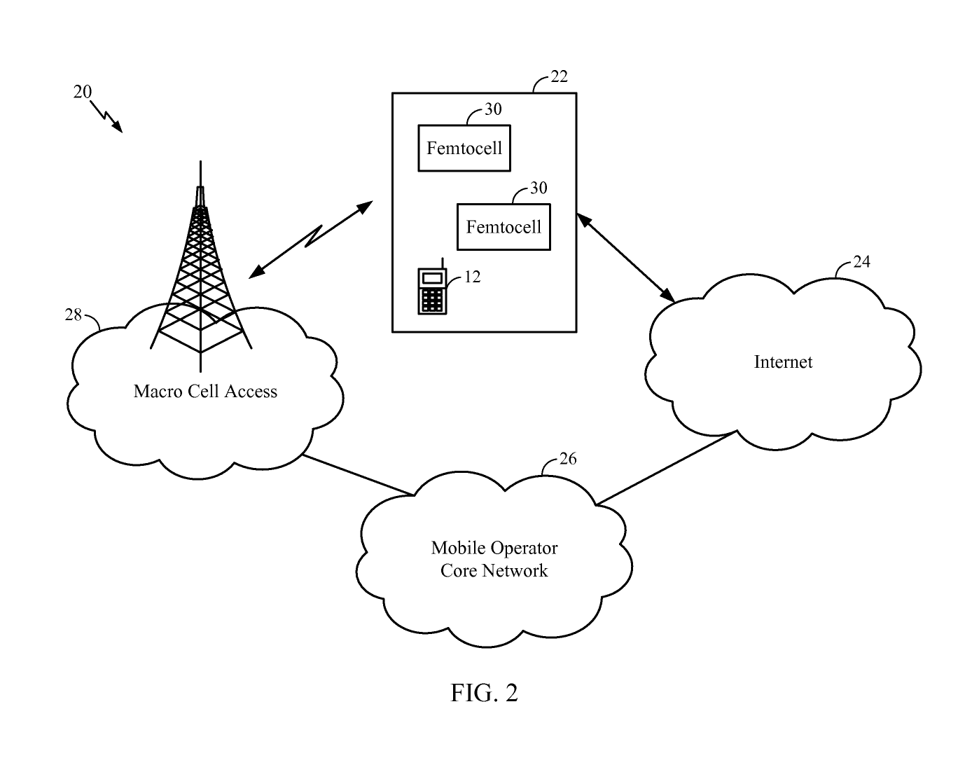

Referring to FIG. 2, a communication system 20 is shown that enables deployment of femtocells 30 within an example network environment. System 20 can include multiple femtocells 30 (also referred to as access point base stations (APBSs), Home Node B units (HNBs), Home Evolved Node B units (HeNBs), etc.). Femtocells 30 are associated with a small scale network environment 22 (e.g., a user residence or other suitable areas such as an office building, a store or other business, etc.). The femtocells 30 can also be configured to serve associated and/or alien mobile devices 12. Here, femtocells 30 are coupled to the Internet 24 and a mobile operator core network 26 via a broadband connection implemented by a digital subscriber line (DSL) router, a cable modem, a fiber-optic connection, etc. An owner of a femtocell or femtocell 30 can subscribe to mobile communications service offered through mobile operator core network 26. Accordingly, the mobile device 12 can operate both in a macro cellular environment 28 and in a residential small scale network environment 22.

Mobile devices 12 can in some cases be served by a set of femtocells 30 (e.g., femtocells 30 that reside within the small scale network environment 22) in addition to a macro cell mobile network 28. As defined herein, a “home” APBS is a base station on which a mobile device is authorized to operate, a guest APBS refers to a base station on which a mobile device is temporarily authorized to operate, and an alien APBS is a base station on which the mobile device is not authorized to operate. A femtocell 30 can be deployed on a single frequency or on multiple frequencies, which may overlap with respective macro cell frequencies.

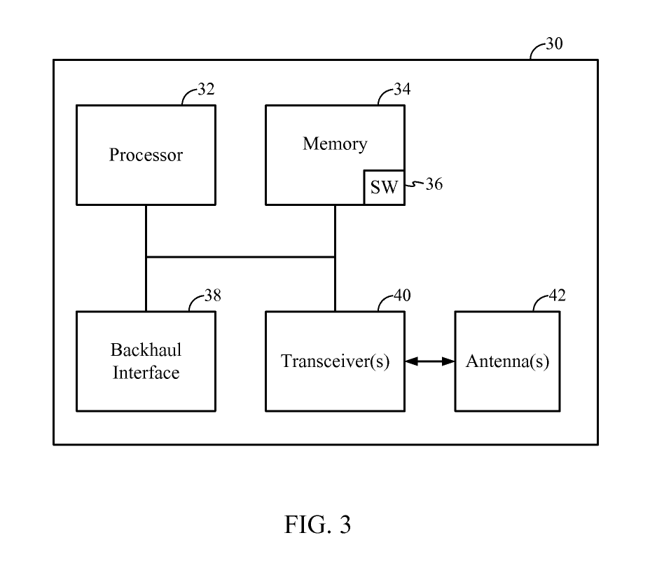

Referring next to FIG. 3, an example one of the femtocells 30 shown in FIG. 2 comprises a computer system including a processor 32, memory 34 including software 36, a backhaul interface 38 and one or more transceivers 40. The transceivers 40 include one or more antennas 42 configured to communicate bi-directionally with the mobile devices 12 and/or base stations 14. Here, the processor 32 is an intelligent hardware device, e.g., a central processing unit (CPU) such as those made by Intel® Corporation or AMD®, a microcontroller, an application specific integrated circuit (ASIC), etc. The memory 34 includes non-transitory storage media such as random access memory (RAM) and read-only memory (ROM). The memory 34 stores the software 36 which is computer-readable, computer-executable software code containing instructions that are configured to, when executed, cause the processor 32 to perform various functions described herein. Alternatively, the software 36 may not be directly executable by the processor 32 but is configured to cause the computer, e.g., when compiled and executed, to perform the functions.

The backhaul interface 38 facilitates communication between the femtocell 30 and a communication network associated with the femtocell 30. The backhaul interface 38 utilizes wired and/or wireless communication means to facilitate communication between the femtocell 30 and the network. For example, the backhaul interface 38 can enable communication between the femtocell 30 and network via an overlying broadband communications network implemented by, e.g., cable, digital subscriber line (DSL), fiber optic, etc. The backhaul interface 38 can facilitate communication between the femtocell 30 and network either directly or indirectly, such as through a femtocell management system or the like.

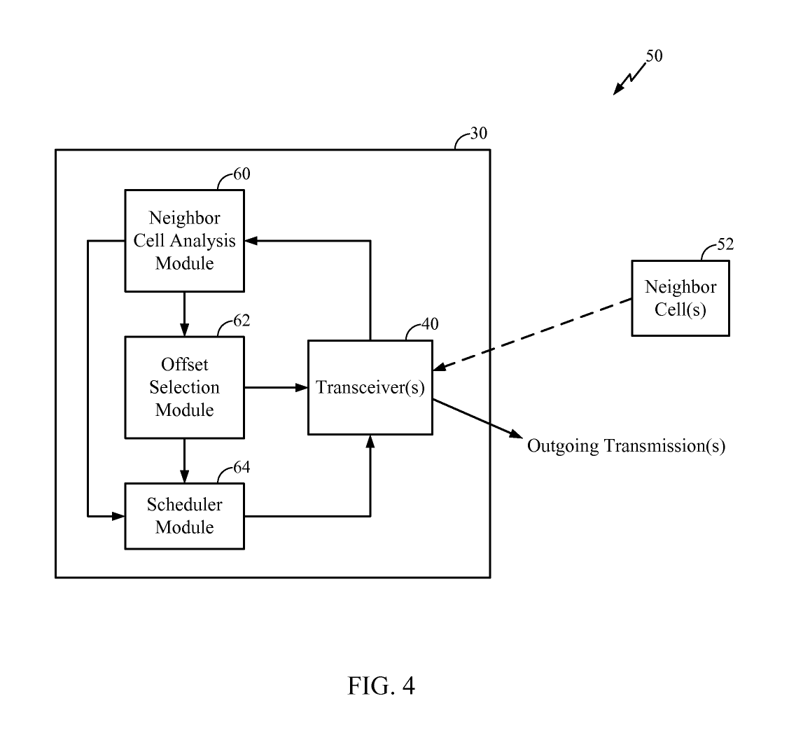

A femtocell 30 or other smaller cell in a communication system 50 can operate to manage transmissions of beacons and/or other information as shown in FIG. 4. The femtocell 30 in FIG. 4 includes a neighbor cell analysis module 60 configured to identify a neighboring macrocell or other neighbor cell 52 and a time division multiplexing (TDM) overhead or signaling channel offset of the neighbor cell 52. The femtocell 30 further includes an offset selection module 62 configured to select a local offset that differs from the channel offset of the neighbor cell 52 as well as a scheduler module 64 configured to generate a transmission schedule such that pilot transmissions and/or other outgoing transmissions by the femtocell 30 (e.g., transmissions conducted via a transceiver 40) are omitted for at least a portion of transmission intervals of the neighbor cell 52. The transmission intervals of the neighbor cell 52 are identified according to the channel offset of the neighbor cell 52, e.g., based on signals received from the neighbor cell 52. By managing transmissions at the femtocell 30 in this manner, interference to the neighbor cell 52 can be substantially avoided. Techniques for managing transmission according to the system shown in FIG. 4 are described in further detail below.

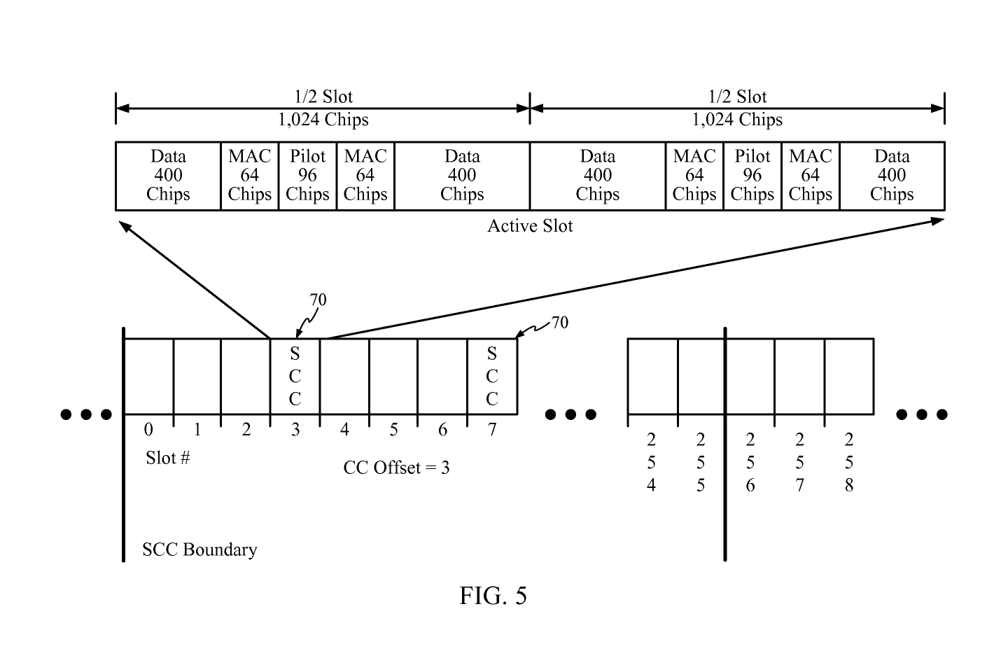

In TDMA systems with system synchronization, such as Evolution-Data Optimized (EV-DO) systems or the like, the downlink communication channel (e.g., the communication channel from a network cell to one or more network users) includes a pilot channel, a MAC channel, and a traffic channel. Downlink transmissions contain pilot, MAC, and traffic bursts that are combined using time-division multiplexing. Transmissions are structured in time according to units referred to as slots or the like, which can be any suitable length (e.g., 1.67 ms, or 2048 chips). Within each half-slot of transmission, a pilot burst (e.g., of 96 chips or any other suitable length) may be present in the middle of the half-slot. The pilot burst is adjacent to two MAC bursts (e.g., each with a length of 64 chips). The remaining chips of the half-slot are occupied by data traffic. The above transmission structure is illustrated by FIG. 5. It is noted, however, that FIG. 5 illustrates merely an example transmission structure that can be utilized and that other structures are possible.

On the traffic channel within the transmission structure shown in FIG. 5, interleaving across slots is used to provide time-diversity for the traffic channel packets. There are four interleaves available on the downlink, each of which is referenced by its corresponding traffic channel offset in slots.

The Synchronous Control Channel (SCC) 70 is a portion of the traffic channel that is used to send overhead messages on the downlink. SCC data packets are sent through the traffic channel bursts at regular intervals, e.g., once every 256 slots. Each sector in the network can use a particular traffic channel offset for each SCC packet transmission; in this context the offset is also referred to as the CC offset. The signaling or overhead channel offset is measured with respect to the SCC boundary, which occurs at regular intervals (e.g., every 256 slots), and all sectors in the network are synchronized with this boundary. Different channel offsets may be used across different sectors, or a single channel offset may be used for all or part of the entire network. An example transmission scheme for the SCC 70 in time, as well as an example structure that can be utilized by the SCC 70, are also illustrated in FIG. 5. In particular, FIG. 5 illustrates a case in which SCC packets are indicated for a CC offset of 3. For each slot on which transmission occurs, an example structure for the pilot, MAC and data bursts is further shown by FIG. 5. If no data is to be sent in a given slot, the traffic burst is empty.

The femtocell 30 can transmit beacons, which are transmissions on the downlink which assist idle mobile devices 12 (not shown in FIG. 5) in finding a femtocell BS. Once an idle AT 12 comes within range of an associated femtocell 30, the AT 12 detects the beacon of that femtocell 30 and performs an idle handoff. Once the handoff is complete, the AT 12 can then decode the overhead messages sent from the beacon. From these overhead messages, the AT 12 obtains a redirect message instructing the AT 12 to switch to the frequency of the femtocell 30.

In order for the AT 12 to decode the messages from the beacon, the SCC boundary for the beacon is synchronized with that of the macro network. This synchronization can be achieved through, e.g., a satellite positioning system (SPS) (e.g., Global Positioning System (GPS), GLONASS, Galileo, Beidou, etc.) or a Network Listen Mode that enables the femtocell 30 to monitor the macro network transmissions. In an example where beacons carry only CC messages, the beacons need not transmit during the MAC bursts or the pilot bursts associated with non-CC packets. In other cases, as described below, pilot burst slots are utilized for warmup just prior to the SCC boundary to allow for idle handoff.

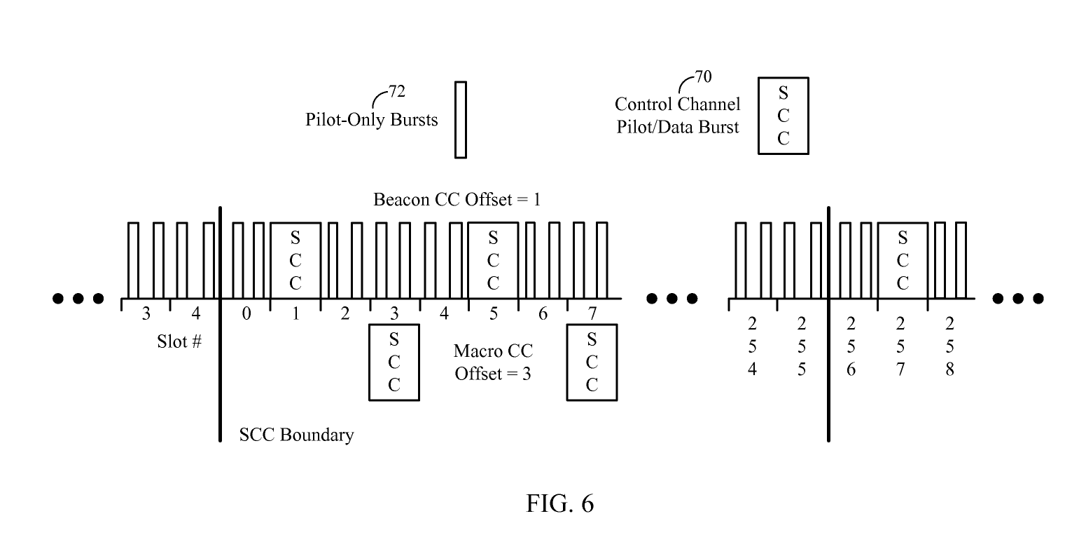

The femtocell 30 and neighbor cell 52 shown in FIG. 4 can operate using different frequencies for downlink and/or uplink transmission. However, in order to enable mobile devices 12 to detect a given femtocell 30, the femtocell 30 transmits beacons using the frequency of the neighbor cell 52. This can in some cases result in collisions between transmissions of the neighbor cell 52 and pilot bursts 72 of the femtocell 30, leading to interference to users of the neighbor cell 52, as shown by FIG. 6. To limit this interference, various mechanisms can be deployed by the femtocell 30 as described below. While some of the techniques provided below are described in the context of n EV-DO system, similar techniques can be applied to any communication system in which signals are processed for transmission using time division multiplexing and respective cells within the system are synchronized in time. For example, the techniques could also apply to a CDMA system in which cells within the system can be configured to transmit signals according to a schedule in time. Other system configurations are also possible.

A femtocell can conduct beacon transmissions to avoid interference to a macro signaling or overhead channel in at least the following manners. In one aspect, the femtocell 30 sends the beacon on an alternate channel offset that is separated from the macro network channel offset. The macro network channel offset can be determined according to, e.g., the channel offset of the nearest macro sector and/or other metrics. Further, the femtocell 30 can apply a gating pattern for beacon transmission that avoids interfering with macro signaling or overhead channel packets, including the pilot and MAC bursts that are associated with the macro signaling or overhead channel packets. A zero- or near-zero-power transmission can be achieved via gating by, e.g., applying a digital gain of 0, shutting off the transmit chain of the beacon, etc. By utilizing these techniques, beacon transmission is configured to avoid interference with the macro signaling or overhead channel while being sufficient to redirect idle mobile devices 12 to the femtocell 30.

An example algorithm that can be utilized by a femtocell 30 to manage transmission of beacon signals operates as follows. First, the femtocell 30 detects which offsets are used by neighbor cell(s) 52. A macro neighbor (e.g., a strongest neighbor cell 52, etc.) is identified, and its channel offset is assigned to the variable CC offset macro. This can be performed by, e.g., the neighbor cell analysis module 60 at the femtocell 30 and/or other means. Next, for the femtocell beacon signal, a channel offset is chosen that differs from that of the neighbor cell(s) 52. This offset is assigned to the variable CC offset beacon. In a scenario with four possible offsets, the femtocell offset can be chosen (e.g., by an offset selection module 62 or other means) to maximize the distance from the offset of the strongest neighbor cell 52, e.g., such that CC offset beacon=(CC offset macro+2) mod 4. Other techniques for selecting the offset are also possible.

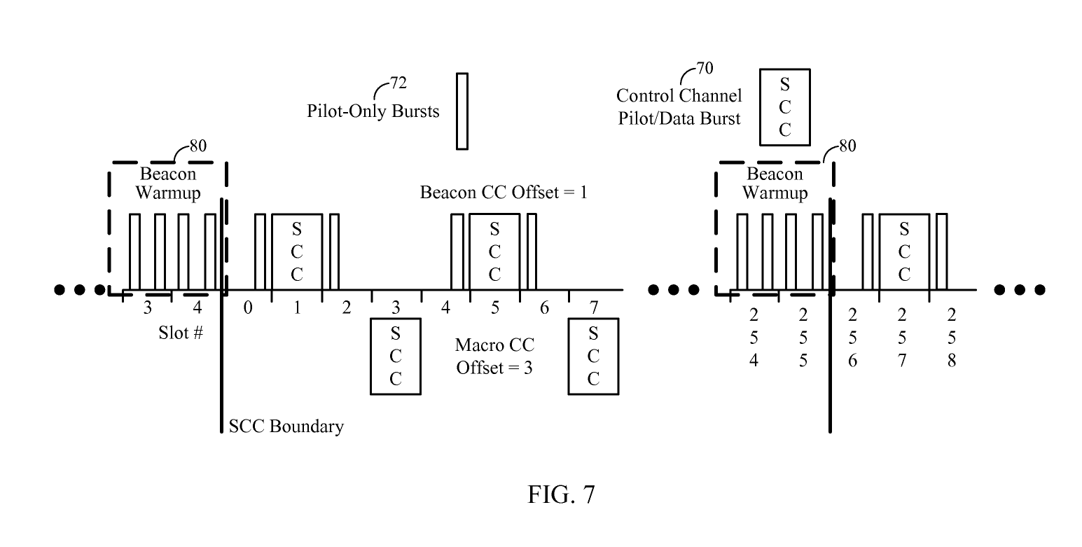

Further, during interlaces where no data is being sent by the femtocell 30 from the beacon, a scheduler module 64 or other suitable means can facilitate transmission of only partial pilots, as shown by FIG. 7. For instance, the scheduler module 64 can implement a pilot gating pattern such that for 18-24 slots prior to the SCC boundary, the femtocell 30 begins transmitting beacon pilot bursts 72 until the SCC boundary is reached. MAC and traffic bursts may or may not be transmitted from the beacon over this duration. This operation is referred to as beacon warmup 80, and is utilized for idle handoff to the beacon sector. As further shown by FIG. 7, for each slot of the beacon packet, the pilot and traffic bursts of the packet are transmitted. Additionally, the pilot burst for the second half-slot of the channel just prior to the beacon offset, as well as the pilot burst for the first half-slot of the channel just after the beacon offset, are additionally transmitted to aid associated mobile devices 12 in pilot discovery. For all other slots, no traffic, pilot or MAC bursts are transmitted. Thus, as shown by FIG. 7, a femtocell 30 avoids interfering with a neighbor cell 52 on slots in which the neighbor cell 52 conducts transmission, e.g., slots 3 and 7. In the procedure set forth above, the neighbor cell analysis module 60, the offset selection module 62 and/or the scheduler module 64 can be implemented by various means, such as by software 36 stored on a memory 34 and executed by a processor 32, or the like.

In the above procedure, beacon warmup 80 is utilized since the AT 12 searches for new sectors prior to the SCC boundary. As a result, the beacon is transmitted in order for the AT 12 to hand off to the femtocell 30 it prior to the SCC boundary. The pilot and traffic bursts of the beacon packet and the pilot bursts adjacent to the beacon packet are transmitted since they aid in the channel estimation performed when decoding the beacon packet, while at the same time they limit interference to slots which do not contain macro signaling or overhead channel packets. Bursts are silenced on the remaining slots to avoid interference on the remaining slots.

Returning to FIG. 6, a beacon with standard transmission is illustrated. For the macro transmission, it is assumed that pilot, MAC and data bursts are transmitted on every slot even though only SCC packets are illustrated. For the beacon transmission, all signals illustrated in FIG. 6 are transmitted.

In contrast, the above properties of beacon transmission overlaid with the macro signaling or overhead channel transmission shown in FIG. 6 are illustrated by FIG. 7, assuming the offset selection scheme provided above. Comparison between FIG. 6 and FIG. 7 shows the reduction in beacon pilot interference to the macro SCC, which is apparent in FIG. 6 and substantially eliminated in FIG. 7.

While the above techniques are described for a system with a single neighbor cell 52, the techniques could also be extended to reduce interference to more than one neighbor cell 52. If the multiple neighbor cells 52 utilize the same TDM signaling or overhead channel offset, the offset selection and scheduling can be performed by the femtocell 30 in the same manner as that shown above. In the event that the TDM signaling or overhead channel offsets of the neighbor cells 52 differ, the femtocell 30 can account for each of the relevant offsets in its offset selection and scheduling.

Further, if the neighbor list associated with a given femtocell 30 is large (e.g., having a size greater than 16, etc.), the beacon warmup 80 described above may not be sufficiently long for the AT 12 to find the beacon pilot in all cases. If this is determined to be the case, e.g., as a function of neighbor list size as advertised or otherwise indicated by a neighbor cell 52, the beacon warmup 80 can be extended into the first few slots after the SCC boundary in order to improve probability of discovery and handoff onto the beacon pilot.

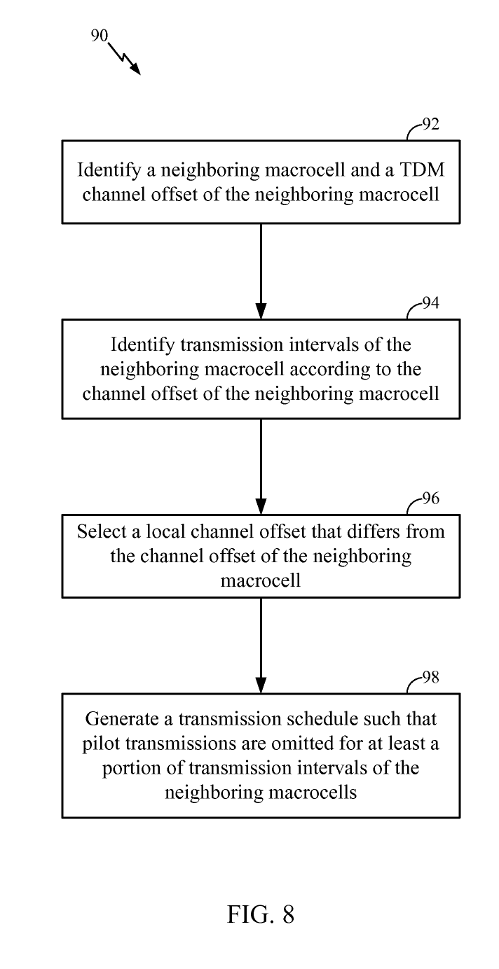

Referring next to FIG. 8, with further reference to FIGS. 1-7, a process 90 of controlling transmission of beacons by a femtocell 30 in a wireless communication system includes the stages shown. The process 90 is, however, an example only and not limiting. The process 90 can be altered, e.g., by having stages added, removed, rearranged, combined, and/or performed concurrently. Still other alterations to the process 90 as shown and described are possible.

At stage 92, a neighboring macrocell, such as a neighbor cell 52, and a TDM signaling or overhead channel offset of the neighboring macrocell are identified. Next, at stage 94, transmission intervals of the neighboring macrocell identified at stage 92 are identified according to the signaling or overhead channel offset of the neighboring macrocell, as further identified at stage 92. The identification operations at stage 92 and/or 94 can be performed by, e.g., a neighbor cell analysis module 60, which may be implemented by a processor 32 executing software 36 stored on a memory 34 and/or by other means.

At stage 96, a local channel offset is selected that differs from the signaling or overhead channel offset of the neighboring macrocell identified at stage 92. Selection of the local channel offset at stage 96 can be performed by, e.g., an offset selection module 62, which may be implemented by a processor 32 executing software 36 stored on a memory 34 and/or by other means. In some cases, the offset can be selected at stage 96 to maximize the distance in time between the local channel offset and the signaling or overhead channel offset of the neighboring macrocell. For instance, if the signaling or overhead channel offset of the neighboring macrocell is an integer N between 0 and 3, the local channel offset can be selected according to (N+2) mod 4. Further, while FIG. 8 illustrates a process in which the signaling or overhead channel offset of one neighboring macrocell is considered, the offset selection at stage 96 can be modified to accommodate any suitable number of neighboring macrocells and their corresponding signaling or overhead channel offsets.

At stage 98, a transmission schedule is generated such that pilot transmission are omitted for at least a portion of transmission intervals of the neighboring macrocell. The transmission schedule can be generated by, e.g., a scheduler module 64, which may be implemented by a processor 32 executing software 36 stored on a memory 34 and/or by other means. The transmission schedule can operate to gate off at least a portion of pilot transmissions that would otherwise collide with transmissions of the neighboring macrocell. For instance, as described above, a femtocell 30 can transmit pilot, MAC and/or traffic bursts within and adjacent to a designated slot and/or a beacon warmup period and null or otherwise abstain from the pilot, MAC and/or traffic transmissions at other times.

One or more of the components, steps, features and/or functions illustrated in FIGS. 1, 2, 3, 4, 5, 6 and/or 7 may be rearranged and/or combined into a single component, step, feature or function or embodied in several components, steps, or functions. Additional elements, components, steps, and/or functions may also be added without departing from the invention. The apparatus, devices, and/or components illustrated in FIGS. 1, 2, 3, 4, 5, 6 and/or 7 may be configured to perform one or more of the methods, features, or steps described in FIG. 8. The novel algorithms described herein may also be efficiently implemented in software and/or embedded in hardware.

Also, it is noted that at least some implementations have been described as a process that is depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. A process may correspond to a method, a function, a procedure, a subroutine, a subprogram, etc. When a process corresponds to a function, its termination corresponds to a return of the function to the calling function or the main function.

Moreover, embodiments may be implemented by hardware, software, firmware, middleware, microcode, or any combination thereof. When implemented in software, firmware, middleware or microcode, the program code or code segments to perform the necessary tasks may be stored in a machine-readable medium such as a storage medium or other storage(s). A processor may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

The terms “machine-readable medium,” “computer-readable medium,” and/or “processor-readable medium” may include, but are not limited to portable or fixed storage devices, optical storage devices, and various other non-transitory mediums capable of storing, containing or carrying instruction(s) and/or data. Thus, the various methods described herein may be partially or fully implemented by instructions and/or data that may be stored in a “machine-readable medium,” “computer-readable medium,” and/or “processor-readable medium” and executed by one or more processors, machines and/or devices.

The methods or algorithms described in connection with the examples disclosed herein may be embodied directly in hardware, in a software module executable by a processor, or in a combination of both, in the form of processing unit, programming instructions, or other directions, and may be contained in a single device or distributed across multiple devices. A software module may reside in RAM memory, flash memory, ROM memory, EPROM memory, EEPROM memory, registers, hard disk, a removable disk, a CD-ROM, or any other form of storage medium known in the art. A storage medium may be coupled to the processor such that the processor can read information from, and write information to, the storage medium. In the alternative, the storage medium may be integral to the processor.

Those of skill in the art would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system.

The various features of the invention described herein can be implemented in different systems without departing from the invention. It should be noted that the foregoing embodiments are merely examples and are not to be construed as limiting the invention. The description of the embodiments is intended to be illustrative, and not to limit the scope of the claims. As such, the present teachings can be readily applied to other types of apparatuses and many alternatives, modifications, and variations will be apparent to those skilled in the art.

What is claimed is:

1. A system for managing transmissions within a wireless communication system, the system comprising:
a neighbor cell analysis module configured to identify a neighboring macrocell and a time division multiplexing (TDM) channel offset of the neighboring macrocell, the channel offset corresponding to at least one of a signaling channel or an overhead channel;
an offset selection module communicatively coupled to the neighbor cell analysis module and configured to select a local channel offset that differs from the channel offset of the neighboring macrocell; and
a scheduler module communicatively coupled to the neighbor cell analysis module and the offset selection module and configured to generate a transmission schedule such that first transmissions are omitted for at least a portion of transmission intervals of the neighboring macrocell;
wherein the transmission intervals of the neighboring macrocell are identified according to the channel offset of the neighboring macrocell; and
wherein the first transmissions comprise at least one of pilot transmissions, medium access control (MAC) transmissions or traffic transmissions.

2. The system of claim 1 wherein the offset selection module is further configured to select the local channel offset such that a distance in time between the local channel offset and the channel offset of the neighboring macrocell is maximized.

3. The system of claim 2 wherein the channel offset of the neighboring macrocell is an integer N between 0 and 3 and the local channel offset is selected according to (N+2) mod 4.

4. The system of claim 1 wherein the scheduler module is further configured to generate the transmission schedule such that the first transmissions are omitted for at least a portion of the transmission intervals of the neighboring macrocell that correspond to interlaces in which no data are locally transmitted.

5. The system of claim 1 wherein the scheduler module is further configured to schedule the first transmissions for a warmup period preceding a time interval corresponding to a synchronous control channel (SCC) boundary of the neighboring macrocell.

6. The system of claim 5 wherein the scheduler module is further configured to extend the warmup period beyond the time interval corresponding to the SCC boundary of the neighboring macrocell as a function of neighbor list size indicated by the neighboring macrocell.

7. The system of claim 1 wherein the scheduler module is further configured to schedule pilot and traffic burst transmissions at each local channel slot defined according to the local channel offset.

8. The system of claim 7 wherein the scheduler module is further configured to schedule pilot burst transmissions at one or more of a first half-slot immediately preceding each local channel slot or a second half-slot immediately following each local channel slot.

9. The system of claim 1 wherein the neighboring macrocell is a strongest neighboring macrocell.

10. The system of claim 1 wherein the neighbor cell analysis module is further configured to identify a plurality of neighboring macrocells and a plurality of TDM channel offsets of the neighboring macrocells and the scheduler module is further configured to generate the transmission schedule such that the first transmissions are omitted for at least a portion of the transmission intervals of the plurality of neighboring macrocells as determined according to channel offsets of the plurality of neighboring macrocells.

11. A method comprising:
identifying a neighboring macrocell and a time division multiplexing (TDM) channel offset of the neighboring macrocell, the channel offset corresponding to at least one of a signaling channel or an overhead channel;
selecting a local channel offset that differs from the channel offset of the neighboring macrocell; and
generating a transmission schedule such that first transmissions are omitted for at least a portion of transmission intervals of the neighboring macrocell;
wherein the transmission intervals of the neighboring macrocell are identified according to the channel offset of the neighboring macrocell; and
wherein the first transmissions comprise at least one of pilot transmissions, medium access control (MAC) transmissions or traffic transmissions.

12. The method of claim 11 wherein selecting the local channel offset comprises selecting the local channel offset such that a distance in time between the local channel offset and the channel offset of the neighboring macrocell is maximized.

13. The method of claim 12 wherein the channel offset of the neighboring macrocell is an integer N between 0 and 3 and selecting the local channel offset comprises selecting the local channel offset according to (N+2) mod 4.

14. The method of claim 11 wherein generating the transmission schedule comprises generating the transmission schedule such that the first transmissions are omitted for at least a portion of the transmission intervals of the neighboring macrocell that correspond to interlaces in which no data are locally transmitted.

15. The method of claim 11 wherein generating the transmission schedule comprises scheduling the first transmissions for a warmup period preceding a time interval corresponding to a synchronous control channel (SCC) boundary of the neighboring macrocell.

16. The method of claim 15 wherein generating the transmission schedule further comprises extending the warmup period beyond the time interval corresponding to the SCC boundary of the neighboring macrocell as a function of neighbor list size indicated by the neighboring macrocell.

17. The method of claim 11 wherein generating the transmission schedule comprises scheduling pilot and traffic burst transmissions at each local channel slot defined according to the local channel offset.

18. The method of claim 17 wherein generating the transmission schedule further comprises scheduling pilot burst transmissions at one or more of a first half-slot immediately preceding each local channel slot or a second half-slot immediately following each local channel slot.

19. The method of claim 11 wherein the neighboring macrocell is a strongest neighboring macrocell.

20. The method of claim 11 wherein the identifying comprises identifying a plurality of neighboring macrocells and a plurality of TDM channel offsets of the neighboring macrocells and generating the transmission schedule comprises generating the transmission schedule such that the first transmissions are omitted for at least a portion of the transmission intervals of the plurality of neighboring macrocells as determined according to channel offsets of the plurality of neighboring macrocells.

21. A system for controlling interference associated with transmissions within a wireless communication system, the system comprising:
means for identifying a neighboring macrocell;
means for identifying a time division multiplexing (TDM) channel offset of the neighboring macrocell;
means for selecting a local channel offset that differs from the channel offset of the neighboring macrocell; and
means for generating a transmission schedule such that first transmissions are omitted for at least a portion of transmission intervals of the neighboring macrocell;
wherein the transmission intervals of the neighboring macrocell are identified according to the channel offset of the neighboring macrocell; and
wherein the first transmissions comprise at least one of pilot transmissions, medium access control (MAC) transmissions or traffic transmissions.

22. The system of claim 21 wherein the means for selecting the local channel offset is configured to select the local channel offset such that a distance in time between the local channel offset and the channel offset of the neighboring macrocell is maximized.

23. The system of claim 22 wherein the channel offset of the neighboring macrocell is an integer N between 0 and 3 and the local channel offset is selected according to (N+2) mod 4.

24. The system of claim 21 wherein the means for generating the transmission schedule is configured to generate the transmission schedule such that the first transmissions are omitted for at least a portion of the transmission intervals of the neighboring macrocell that correspond to interlaces in which no data are locally transmitted.

25. The system of claim 21 wherein the means for generating the transmission schedule is configured to schedule the first transmissions for a warmup period preceding a time interval corresponding to a synchronous control channel (SCC) boundary of the neighboring macrocell.

26. The system of claim 25 wherein the means for generating the transmission schedule is further configured to extend the warmup period beyond the time interval corresponding to the SCC boundary of the neighboring macrocell according to a neighbor list size indicated by the neighboring macrocell.

27. The system of claim 21 wherein the means for generating the transmission schedule is configured to schedule pilot and traffic burst transmissions at each local channel slot defined according to the local channel offset.

28. The system of claim 27 wherein the means for generating the transmission schedule is further configured to schedule pilot burst transmissions at one or more of a first half-slot immediately preceding each local channel slot or a second half-slot immediately following each local channel slot.

29. The system of claim 21 wherein the neighboring macrocell is a strongest neighboring macrocell.

30. The system of claim 21 wherein:
the means for identifying the neighboring macrocell is configured to identify a plurality of neighboring macrocells;
the means for identifying the TDM channel offset is configured to identify a plurality of TDM channel offsets of the neighboring macrocells; and
the means for generating the transmission schedule is configured to generate the transmission schedule such that the first transmissions are omitted for at least a portion of the transmission intervals of the plurality of neighboring macrocells as determined according to channel offsets of the plurality of neighboring macrocells.

31. A computer program product residing on a processor-readable medium and comprising processor-readable instructions configured to cause a processor to:
identify a neighboring macrocell and a time division multiplexing (TDM) channel offset of the neighboring macrocell;
select a local channel offset that differs from the channel offset of the neighboring macrocell; and
generate a transmission schedule such that first transmissions are omitted for at least a portion of transmission intervals of the neighboring macrocell;
wherein the transmission intervals of the neighboring macrocell are identified according to the channel offset of the neighboring macrocell; and
wherein the first transmissions comprise at least one of pilot transmissions, medium access control (MAC) transmissions or traffic transmissions.

32. The computer program product of claim 31 wherein the instructions configured to cause the processor to select the local channel offset are further configured to cause the processor to select the local channel offset such that a distance in time between the local channel offset and the channel offset of the neighboring macrocell is maximized.

33. The computer program product of claim 32 wherein the channel offset of the neighboring macrocell is an integer N between 0 and 3 and selecting the local channel offset comprises selecting the local channel offset according to (N+2) mod 4.

34. The computer program product of claim 31 wherein the instructions configured to cause the processor to generate the transmission schedule comprises instructions configured to cause the processor to generate the transmission schedule such that the first transmissions are omitted for at least a portion of the transmission intervals of the neighboring macrocell that correspond to interlaces in which no data are locally transmitted.

35. The computer program product of claim 31 wherein the instructions configured to cause the processor to generate the transmission schedule comprises instructions configured to cause the processor to schedule the first transmissions for a warmup period preceding a time interval corresponding to a synchronous control channel (SCC) boundary of the neighboring macrocell.

36. The computer program product of claim 35 wherein the instructions configured to cause the processor to generate the transmission schedule comprises instructions configured to cause the processor to extend the warmup period beyond the time interval corresponding to the SCC boundary of the neighboring macrocell as a function of neighbor list size indicated by the neighboring macrocell.

37. The computer program product of claim 31 wherein the instructions configured to cause the processor to generate the transmission schedule comprises instructions configured to cause the processor to schedule pilot and traffic burst transmissions at each local channel slot defined according to the local channel offset.

38. The computer program product of claim 37 wherein the instructions configured to cause the processor to generate the transmission schedule comprises instructions configured to cause the processor to schedule pilot burst transmissions at one or more of a first half-slot immediately preceding each local channel slot or a second half-slot immediately following each local channel slot.

39. The computer program product of claim 31 wherein the neighboring macrocell is a strongest neighboring macrocell.

40. The computer program product of claim 31 wherein:
the instructions configured to cause the processor to identify are further configured to cause the processor to identify a plurality of neighboring macrocells and a plurality of TDM channel offsets of the neighboring macrocells; and
the instructions configured to cause the processor to generate the transmission schedule are further configured to cause the processor to generate the transmission schedule such that the first transmissions are omitted for at least a portion of the transmission intervals of the plurality of neighboring macrocells as determined according to channel offsets of the plurality of neighboring macrocells.
